(19) United States
(12) Patent Application Publication
(10) Pub. No.: US 2020/0411963 A1
(43) Pub. Date: Dec. 31, 2020

(54) RADIATING DEVICE AND BASE STATION ANTENNA

(71) Applicant: AAC Technologies Pte. Ltd., Singapore city (SG)

(72) Inventors: Li Han, Shenzhen (CN); Qingchen Chu, Shenzhen (CN); Hua Jiang, Shenzhen (CN)

(21) Appl. No.: 16/992,129

(22) Filed: Aug. 13, 2020

Related U.S. Application Data
(63) Continuation of application No. PCT/CN2019/094086, filed on Jun. 30, 2019.

(51) Int. Cl. H01Q 1/24; H01Q 1/14

(52) U.S. Cl. CPC H01Q 1/246; H01Q 1/14

(57) ABSTRACT

An radiating device includes a vibrator radiator; a supporting plate parallel to and spaced apart from the vibrator radiator; a vibrator support provided between the vibrator radiator and the supporting plate; four vibrator radiating wires; and two differential feeding wires. The vibrator support includes an annular body and four supporting tabs extending outward from an outer periphery of the body and equally distributed in a circumference of the body. The supporting tab is perpendicularly connected to the supporting plate. Each differential feeding wire includes a differential feeding port and two feeding output ports that are respectively connected to two vibrator radiating wires that are not adjacent in the circumference of the body. The vibrator radiator, the supporting plate, the vibrator support, the vibrator radiating wire, and the differential feeding wire are manufactured separately and then assembled together, which simplifies the assembly and reduces assembly cost.

### TECHNICAL FIELD

The present invention relates to the field of communication technology and, in particular, to a radiating device and a base station antenna.

### BACKGROUND

With the development of the communication technology, requirements for base station antennas are becoming increasingly higher, and control on bandwidths and cost of the base station antennas are becoming increasingly stricter. Most vibrators of radiating devices of the base-station antennas still employ printed circuit board (PCB), but assembly cost of the PCB is relatively high. Therefore, it is necessary to provide a radiating device with low assembly cost.

### SUMMARY

A radiating device and a base station antenna are provided, which solve the technical problem that the vibrator of the radiating device of the base station antenna have relatively high assembly cost due to employing the PCB.

In a first aspect, the present invention provides a radiating device, including:

a vibrator radiator;

a supporting plate arranged to and spaced apart from the vibrator radiator;

a vibrator support provided between the vibrator radiator and the supporting plate, wherein the vibrator support includes an body that is annular, and four supporting tabs extending outward from an outer periphery of the body and equally distributed in a circumference of the body, and each of the four supporting tabs is perpendicularly connected to the supporting plate;

four vibrator radiating wires arranged on the four supporting tabs, respectively, and spaced apart from and coupled with the vibrator radiator; and

two differential feeding wires provided on the supporting plate, wherein each of the two differential feeding wires includes a differential feeding port and two feeding output ports, and the two feeding output ports are respectively connected to two vibrator radiating wires of the four vibrator radiating wires that are not adjacent in the circumference of the body.

As an improvement, the vibrator radiator is provided with at least three snap grooves, the vibrator support is provided with at least three snap pillars matching the at least three snap grooves of the vibrator radiator, and each of the at least three snap pillars is inserted into one of the at least three snap grooves in such a manner that the vibrator support and the vibrator radiator are fixed to each other by a snap-in way.

As an improvement, the supporting plate is provided with four snap grooves, a side of the vibrator support facing away from the vibrator radiator is provided with four snap pillars matching the four snap groove of the supporting plate, and each of the four snap pillars at the side of the vibrator support facing away from the vibrator radiator is inserted into one of the four snap grooves of the supporting plate in such a manner that the vibrator support and the supporting plate are fixed to each other in a snap-in way.

As an improvement, an end of each of the four vibrator radiating wires is weld to one of the two differential feeding wire.

As an improvement, each of the four vibrator radiating wires is formed on the vibrator support by a laser direct structuring process; or each of the four vibrator radiating wires is made into a steel sheet and then pressed on the vibrator support through a hot fusion process.

As an improvement, a distance between a surface of the radiating device facing away from the vibrator support and a surface of the supporting plate facing away from the vibrator support is a height of the radiating device, and when the height of the radiating device is 15 mm, an operating frequency band of the radiating device covers a range from 2500 MHz to 2700 MHz.

As an improvement, coupling radiation of the vibrator radiator and the four vibrator radiating wires forms a wide-frequency-band radiating device having a bandwidth greater than or equal to 500 MHz.

In a second aspect, the present invention provides a base station antenna, including a radiating devices. The radiating device includes: a vibrator radiator, a supporting plate parallel to and spaced apart from the vibrator radiator; a vibrator support provided between the vibrator radiator and the supporting plate, wherein the vibrator support includes an body that is annular, and four supporting tabs extending outward from an outer periphery of the body and equally distributed in a circumference of the body, and each of the four supporting tabs is perpendicularly connected to the supporting plate; four vibrator radiating wires arranged on the four supporting tabs, respectively, and spaced apart from and coupled with the vibrator radiator; and two differential feeding wires provided on the supporting plate, wherein each of the two differential feeding wires includes a differential feeding port and two feeding output ports, and the two feeding output ports are respectively connected to two vibrator radiating wires of the four vibrator radiating wires that are not adjacent in the circumference of the body.

As an improvement, the vibrator radiator is provided with at least three snap grooves, the vibrator support is provided with at least three snap pillars matching the at least three snap grooves of the vibrator radiator, and each of the at least three snap pillars is inserted into one of the at least three snap grooves in such a manner that the vibrator support and the vibrator radiator are fixed to each other by a snap-in way.

As an improvement, the supporting plate is provided with four snap grooves, a side of the vibrator support facing away from the vibrator radiator is provided with four snap pillars matching the four snap grooves of the supporting plate, and each of the four snap pillars at the side of the vibrator support facing away from the vibrator radiator is inserted into one of the four snap grooves of the supporting plate in such a manner that the vibrator support and the supporting plate are fixed to each other in a snap-in way.

As an improvement, an end of each of the four vibrator radiating wires is weld to one of the two differential feeding wire.

As an improvement, each of the four vibrator radiating wires is formed on the vibrator support by a laser direct structuring process; or each of the four vibrator radiating wires is made into a steel sheet and then pressed on the vibrator support through a hot fusion process.

As an improvement, a distance between a surface of the radiating device facing away from the vibrator support and a surface of the supporting plate facing away from the vibrator support is a height of the radiating device, and when the height of the radiating device is 15 mm, an operating frequency band of the radiating device covers a range from 2500 MHz to 2700 MHz.

As an improvement, coupling radiation of the vibrator radiator and the four vibrator radiating wires forms a wide-frequency-band radiating device having a bandwidth greater than or equal to 500 MHz.

The radiating device includes: the vibrator radiator, the supporting plate parallel to and spaced apart from the vibrator radiator; the vibrator support provided between the vibrator radiator and the supporting plate, the vibrator support including the body that is annular and the four supporting tabs extending outward from the outer periphery of the body and equally distributed in the circumference of the body, and each of the four supporting tabs is perpendicularly connected to the supporting plate; the four vibrator radiating wires arranged on the four supporting tabs, respectively, and spaced apart from and coupled with the vibrator radiator; and two differential feeding wires provided on the supporting plate, each of the two differential feeding wires including the differential feeding port and the two feeding output ports, and the two feeding output ports being respectively connected to two vibrator radiating wires of the four vibrator radiating wires that are not adjacent in the circumference of the body. Through manufacturing the vibrator radiator, the supporting plate, the vibrator support, the vibrator radiating wire, and the differential feeding wire separately and then assembling them together, the assembly is simple, the assembly cost is reduced, and the production cost is reduced.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a schematic diagram of a radiating device of a base-station antenna;

FIG. 2 is a perspective exploded schematic diagram of the radiating device shown in FIG. 1;

FIG. 3 is a schematic diagram of the radiating device shown in FIG. 1 when viewing from another perspective;

FIG. 4 is a schematic diagram of the radiating device shown in FIG. 1 when viewing from another perspective;

FIG. 5 is a schematic diagram of the radiating device shown in FIG. 1 when viewing from another perspective; and

FIG. 6 is a diagram showing performance curves of the radiating device shown in FIG. 1.

### DESCRIPTION OF EMBODIMENTS

The present invention will be further described below with reference to the accompany drawings and embodiments.

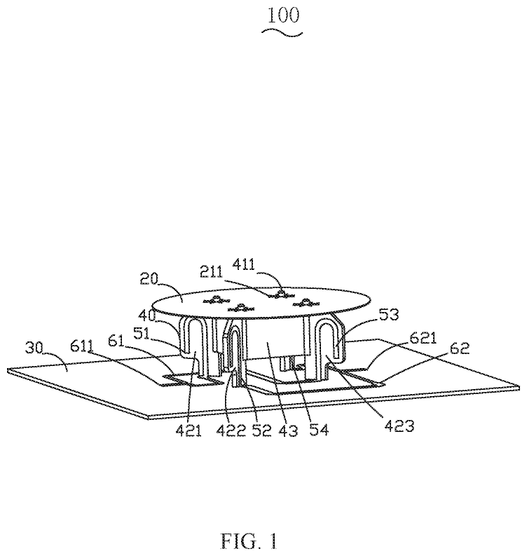

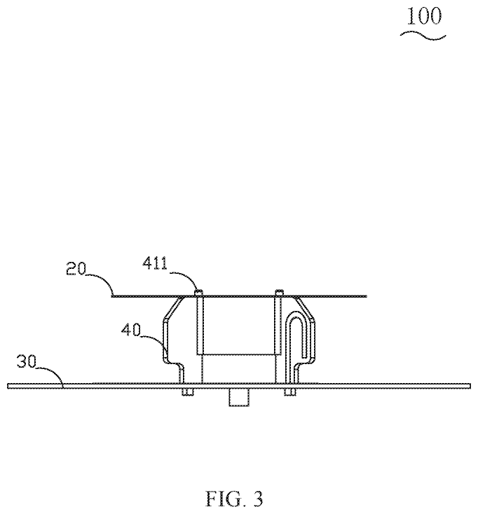

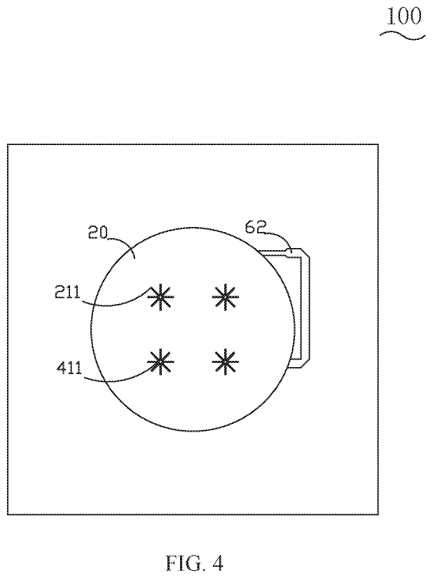

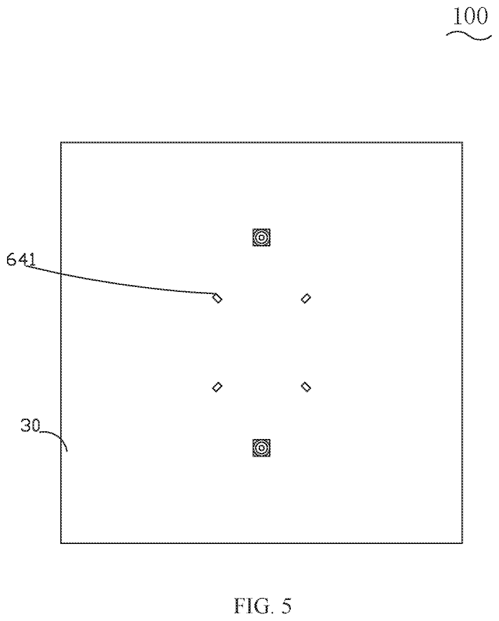

Referring to FIG. 1 to FIG. 5, a base station antenna provided by an embodiment of the present invention includes at least one radiating device 100. The radiating device 100 includes a vibrator radiator 20, a supporting plate 30, a vibrator support 40, four vibrator radiating wires 51, 52, 53, and 54, and two differential feeding wires 61 and 62. The base station antenna is configured to transmit and receive signals by a base station. The vibrator support 40 is configured to support the vibrator radiator 20 and the four vibrator radiating wires 51, 52, 53, and 54, and the vibrator radiator 20 and the vibrator radiating wires 51, 52, 53, and 54 achieve coupling radiation.

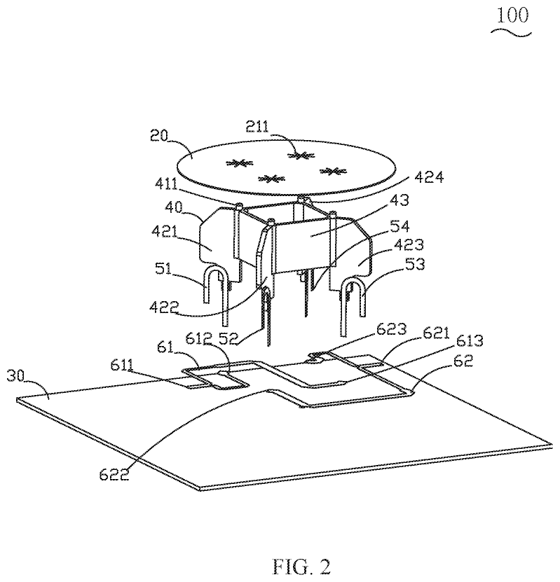

Referring to FIG. 1 and FIG. 2, the vibrator radiator 20 and the supporting plate 30 each can be a planar plate of a shape, such as round, parallelogram and square, or a non-planar plate, such as a curved plate or an arced plate, which is not limited herein. Specifications of the four vibrator radiating wires 51, 52, 53, and 54 are the same. For example, each of the vibrator radiating wires 51, 52, 53, and 54 can be inverted J-shaped, and it can be understood that the inversion here is relative to the supporting plate 30. The vibrator support 40 is made of non-conductive material. The vibrator support 40 includes an annular body 43 and four supporting tabs 421, 422, 423, and 424 extending outward from an outer periphery of the body. Each of the supporting tabs 421, 422, 423, and 424 is perpendicularly connected to the supporting plate 30, and the four supporting tabs 421, 422, 423, and 424 are arranged equally spaced in a circumference of the body. The four vibrator radiating wires 51, 52, 53, and 54 are respectively disposed on the supporting tabs 421, 422, 423, and 424 and spaced apart from and coupled to the vibrator radiator 20. It can be understood that the shape of the vibrator support 40 can also be other shapes, which is not limited herein. The vibrator radiator 20, the supporting plate 30, the vibrator support 40, and the four vibrator radiating wires 51, 52, 53, and 54 can be manufactured using processes such as Laser Direct Structuring (LDS), plastic electroplating, die casting, stamping, 3D printing (a technology using adhesive materials such as powdered metal or plastics to construct objects by layer-by-layer printing).

The vibrator radiator 20 and the supporting plate 30 are parallel to and spaced apart from each other. The vibrator support 40 is provided between the vibrator radiator 20 and the supporting plate 30. The four vibrator radiating wires 51, 52, 53, and 54 are provided on the vibrator support 40. The two differential feeding wires 61 and 62 are provided on the supporting plate 30, The differential feeding wires 61 includes a differential feeding port 611 and two feeding output ports 612 and 613, and the two feeding output ports 612 and 613 are respectively connected to two vibrator radiating wires 51 and 53 that are not adjacent in the circumferential direction of the body. The differential feeding wire 62 includes a differential feeding port 621 and two feeding output ports 622 and 623, and the two feeding output ports 622 and 623 are respectively connected to the two vibrator radiating wires 52 and 54 that are not adjacent in the circumferential direction of the body. The differential feeding wire 61 is configured to differentially feed power to the vibrator radiating wires 51 and 53, and the differential feeding wire 62 is configured to differentially feed power to the vibrator radiating wires 52 and 54. The wiring forms of the two differential feeding wires 61 and 62 can be designed according to a shape of the supporting plate 30 and power feeding requirements, which is not limited here. The vibrator radiator 20, the supporting plate 30, the vibrator support 40, the vibrator radiating wires 51, 52, 53, and 54, and the two differential feeding wires 61, and 62 are separately manufactured and then assembled together, which simplified the assembly, thereby reducing assembly cost and reducing production cost. By feeding power to the radiating device 100 through the feeding output ports 612 and 613 or the feeding output ports 622 and 623, the radiating device 100 transmits and receives signals.

Ends of the vibrator radiating wires 51 and 52 can be electrically connected to the differential feeding wire 61 by any one of electric fusion connection, hot fusion connection, and welding connection, and ends of the vibrator radiating wires 53 and 54 can be electrically connected to the differential feeding wire 62 by any one of electric fusion connection, hot fusion connection, and welding connection. It can be understood that other electrical connection methods can also be used.

Teach of the vibrator radiating wires 51, 52, 53, and 54 is formed on the vibrator support 40 by the LDS process, or each of the vibrator radiating wires 51, 52, 53, and 54 is made into a steel sheet and then pressed on the vibrator support 40 by a hot fusion process.

The two differential feeding wires 61 and 62 are located on the supporting plate 30, and a process can be selected from the related art to provide the two differential feeding wires 61 and 62 on or in the supporting plate 30, which is not limited here.

The four supporting tabs 421, 422, 423, and 424 are arranged equally spaced in the circumference of the body of the vibrator support 40, in such a manner that a plane, in which the two vibrator radiating wires 51 and 53 that are not adjacent in the circumference of the body are located, is orthogonal to a plane in which the two vibrator radiating wires 52 and 54 are located, to make the radiating device 100 generate orthogonal polarization. The vibrator radiating wires 51 and 53 generate linear polarization in one direction, and the vibrator radiating wires 52 and 54 generate linear polarization in one direction. The vibrator radiating wires 51 and 53 have a same operating frequency band and can be simultaneously and mutually separately operated. The vibrator radiating wires 52 and 54 have a same working frequency band and can be simultaneously and mutually separately operated. The orthogonal polarization makes the polarization directions of the vibrator radiating wires 51 and 53 be orthogonal to the vibrator radiating wires 52 and 54, thereby creating relative isolation between the polarization directions of the vibrator radiating wires 51 and 53 and the polarization directions of the vibrator radiating wires 52 and 54, to avoid mutual interference of signals, and improve quality of the antenna received signal and antenna transmitted signal.

In an embodiment of the present invention, center points of the projections of the four vibrator radiating wires 51, 52, 53, and 54 to the vibrator radiator 20 are connected to form a square. Two diagonal lines of the square intersect perpendicularly, and distances between apexes and a center of the square are equal, such that the orthogonal polarization between the vibrator radiating wires 51 and 53 and the vibrator radiating wires 52 and 54 are achieved, and the best relative isolation is created between the vibrator radiating wires 51 and 53 and the vibrator radiating wires 52 and 54, to avoid the mutual interference, thereby improving the quality of the received signals of and the transmitted signals of the radiating device 100.

In an embodiment of the present invention, a long side of a J-shape of each of the vibrator radiating wires 51, 52, 53, and 54 is perpendicular to the vibrator radiator 20, and a short side of the J-shape of each of the vibrator radiating wire 51, 52, 53, and 54 is located at a side of the long side of the J-shape facing away from a central perpendicular line of a square formed by connecting centers of projection lines of the four vibrator radiating wires 51, 52, 53, and 54. Thus, it is beneficial for production and processing, and the quality of the received and transmitted signals of the radiating device 100 are further improved.

The vibrator radiator 20 is provided with at least three snap grooves 211, the vibrator support 40 is provided with a snap pillar 411 matching the snap groove 211 of the vibrator radiator 20, and the snap pillar 411 is inserted into the snap groove 211 in such a manner that the vibrator support 40 and the vibrator radiator 20 are fixed by a snap-in way. It can be understood that the snap groove 211 and the snap pillar 411 achieve interference fitting, which increases firmness of the snap joint. By means of snap joint, the number of welding points 641 is reduced, thereby reducing risk of welding and improving the quality of the radiating device 100. The snap pillar 411 and the snap groove 211 can be selected from the related art, which will not be repeated herein.

The supporting plate 30 is provided with four snap grooves 211, a side of the vibrator support 40 away from the vibrator radiator 20 is provided with a snap pillar 411 matching the snap groove 211 of the supporting plate 30, and the snap pillar 411 at the side of the vibrator support 40 facing away from the vibrator radiator 20 is inserted into the snap groove 211 of the supporting plate 30 in such a manner that the vibrator support 40 and the supporting plate 30 are fixed to each other in a snap-in way. By means of the snap joint, the number of welding points 641 is reduced, thereby reducing the problems caused by welding and improving the quality of the radiating device 100. The snap pillar 411 and the snap groove 211 can be selected from the related art, which will not be repeated herein.

It can be understood that the snap pillar 411 is provided on each of the supporting tabs 421, 422, 423, and 424 of the vibrator support 40, or the snap pillar 411 is provided on a supporting post 43 of the vibrator support 40.

It can be understood that when the supporting plate 30 and the vibrator support 40 are fixed by the snap joint and the vibrator radiator 20 and the vibrator support 40 are fixed by the snap joint, the whole radiating device 100 has only four welding points 641 formed between the four vibrator radiating wires 51, 52, 53, and 54 and the two differential feeding wires 61 and 62, in such a manner that the welding risk of the radiating device 100 is greatly reduced, and the qualities of the radiating device 100 and the base-station antenna are improved.

A distance between a surface of the radiating device 100 at a side facing away from the vibrator support 40 and a surface of the supporting plate 30 at a side facing away from the vibrator support 40 is a height of the radiating device 100, and when the height of the radiating device 100 is 15 mm, the operating frequency band of the radiating device 100 covers a range from 2500 MHz to 2700 MHz. It can be understood that the radiating device of the present invention can also transmit and receive signals with a frequency within a range from 3300 MHz to 3800 MHz and from 4800 MHz to 5000 MHz.

Coupling radiation of the vibrator radiator 20 and the vibrator radiating wires 51, 52, 53, and 54 forms a wide-frequency-band radiating device 100 having a bandwidth greater than or equal to 500 MHz. Therefore, the base station antenna adopting the radiating device 100 can meet application requirements of wide frequency bands.

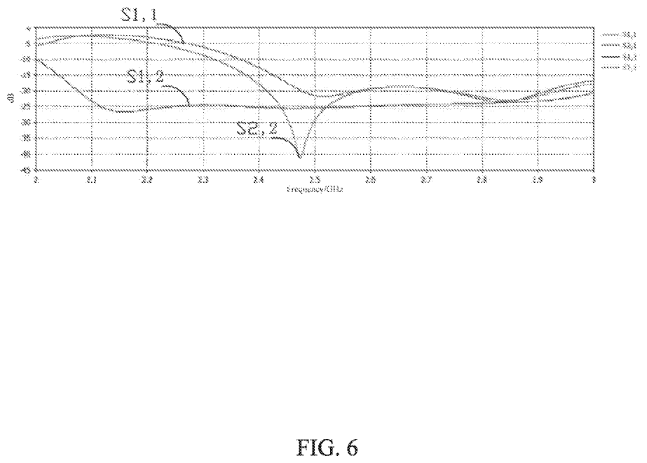

FIG. 6 is a diagram showing performance curves of the radiating device 100 of the present embodiment, and it can be known from the diagram showing the performance curves, that a reflection coefficient is always smaller than a threshold value −10 dB when in the operating frequency band, and the radiating device 100 of the present embodiment has good performance.

The above are only the embodiments of the present invention. It should be noted here that those of ordinary skill in the art can make improvements without departing from the inventive concept of the present invention, but these belong to the protection scope of the present invention.

What is claimed is:

1. A radiating device, comprising:
a vibrator radiator;
a supporting plate parallel to and spaced apart from the vibrator radiator;
a vibrator support provided between the vibrator radiator and the supporting plate, wherein the vibrator support comprises a body that is annular, and four supporting tabs extending outward from an outer periphery of the body and equally distributed in a circumference of the body, and each of the four supporting tabs is perpendicularly connected to the supporting plate;
four vibrator radiating wires arranged on the four supporting tabs, respectively, and spaced apart from and coupled with the vibrator radiator; and
two differential feeding wires provided on the supporting plate, wherein each of the two differential feeding wires comprises a differential feeding port and two feeding output ports, and the two feeding output ports are respectively connected to two vibrator radiating wires of the four vibrator radiating wires that are not adjacent in the circumference of the body.

2. The radiating device as described in claim 1, wherein the vibrator radiator is provided with at least three snap grooves, the vibrator support is provided with at least three snap pillars matching the at least three snap grooves of the vibrator radiator, and each of the at least three snap pillars is inserted into one of the at least three snap grooves in such a manner that the vibrator support and the vibrator radiator are fixed to each other by a snap-in way.

3. The radiating device as described in claim 1, wherein the supporting plate is provided with four snap grooves, a side of the vibrator support facing away from the vibrator radiator is provided with four snap pillars matching the four snap groove of the supporting plate, and each of the four snap pillars at the side of the vibrator support facing away from the vibrator radiator is inserted into one of the four snap grooves of the supporting plate in such a manner that the vibrator support and the supporting plate are fixed to each other in a snap-in way.

4. The radiating device as described in claim 1, wherein an end of each of the four vibrator radiating wires is welded to one of the two differential feeding wire.

5. The radiating device as described in claim 1, wherein each of the four vibrator radiating wires is formed on the vibrator support by a laser direct structuring process; or each of the four vibrator radiating wires is made into a steel sheet and then pressed on the vibrator support through a hot fusion process.

6. The radiating device as described in claim 1, wherein a distance between a surface of the radiating device facing away from the vibrator support and a surface of the supporting plate facing away from the vibrator support is a height of the radiating device, and when the height of the radiating device is 15 mm, an operating frequency band of the radiating device covers a range from 2500 MHz to 2700 MHz.

7. The radiating device as described in claim 1, wherein coupling radiation of the vibrator radiator and the four vibrator radiating wires forms a wide-frequency-band radiating device having a bandwidth greater than or equal to 500 MHz.

8. A base station antenna, comprising a radiating device,
wherein the radiating device comprises:
a vibrator radiator;
a supporting plate parallel to and spaced apart from the vibrator radiator;
a vibrator support provided between the vibrator radiator and the supporting plate, wherein the vibrator support comprises a body that is annular, and four supporting tabs extending outward from an outer periphery of the body and equally distributed in a circumference of the body, and each of the four supporting tabs is perpendicularly connected to the supporting plate;
four vibrator radiating wires arranged on the four supporting tabs, respectively, and spaced apart from and coupled with the vibrator radiator; and
two differential feeding wires provided on the supporting plate, wherein each of the two differential feeding wires comprises a differential feeding port and two feeding output ports, and the two feeding output ports are respectively connected to two vibrator radiating wires of the four vibrator radiating wires that are not adjacent in the circumference of the body.

9. The base station antenna as described in claim 8, wherein the vibrator radiator is provided with at least three snap grooves, the vibrator support is provided with at least three snap pillars matching the at least three snap grooves of the vibrator radiator, and each of the at least three snap pillars is inserted into one of the at least three snap grooves in such a manner that the vibrator support and the vibrator radiator are fixed to each other by a snap-in way.

10. The base station antenna as described in claim 8, wherein the supporting plate is provided with four snap grooves, a side of the vibrator support facing away from the vibrator radiator is provided with four snap pillars matching the four snap grooves of the supporting plate, and each of the four snap pillars at the side of the vibrator support facing away from the vibrator radiator is inserted into one of the four snap grooves of the supporting plate in such a manner that the vibrator support and the supporting plate are fixed to each other in a snap-in way.

11. The base station antenna as described in claim 8, wherein an end of each of the four vibrator radiating wires is weld to one of the two differential feeding wire.
